(19) United States
(12) Patent Application Publication
(10) Pub. No.: US 2025/0384376 A1
(43) Pub. Date: Dec. 18, 2025

(54) Method and System for Data Modeling and Analysis

(71) Applicant: Vigilant AI Inc., Ottawa (CA)

(72) Inventors: Daniel Willis, Smith Falls (CA); Mark Hedley, Dorset (CA); Helge Brueggemann, Vernon (CA); Ronnie Jensen, Kamloops (CA); John Craig, Ottawa (CA); Peter Fong, Stittsville (CA); Shawn Kelly Gardner, Kanata (CA); Yvonne Leonard, North Vancouver (CA)

(21) Appl. No.: 19/028,556

(22) Filed: Jan. 17, 2025

Related U.S. Application Data
(60) Provisional application No. 63/564,050, filed on Mar. 12, 2024.

(51) Int. Cl. G06Q 10/0637

(52) U.S. Cl. CPC G06Q 10/0637

(57) ABSTRACT

A method is disclosed for analysing a data set to determine a first processes. Common elements within the data are identified and associated with the first processes. The common elements are mapped within the first processes to provide an estimated process flow for the first process. Another process is evaluated to determine an absence of one or more common elements common to the estimated process flow. A map is then provided of the process flow indicating events and documents forming the similar processes.

### FIELD OF THE INVENTION

The invention relates to data analysis and more particularly to automated business process analysis.

### BACKGROUND

Traditional business process audits are based on the premise that the general ledger (GL) is the primary source of truth. In a typical enterprise this is not problematic, though it is somewhat limiting. When it comes to a corporation, the general ledger and its supporting financial systems represent approximately 20% of the overall data relating to the processes. This leaves roughly 80% of the data untapped as a source of truth or insight.

Consider the following situation, the GL is being updated at month-end. In the massive rush of month-end, a few errors occur, some of the input data is misinterpreted—input data gets corrupted in the GL and a line or two from the table is deleted with no one aware of the issues. Six months later, an audit is in process. The corrupted GL is deemed the primary source of truth and the audit proceeds. The auditors may or may not discover the errors introduced earlier on. Or they may actually go off in search of the corroborating documents supporting the errors and waste significant time and cost looking for evidence that does not exist. Similarly, when the missing entries are not detected it might be problematic or even catastrophic.

It would be advantageous to provide an improved view of facts, events, and supporting documentation, gaining stronger insights into the financial situation of the organization.

### SUMMARY OF EMBODIMENTS

In accordance with embodiments of the invention there is provided a method comprising: analysing a data set to determine first processes reflected thereby; determining common elements within the first processes; mapping the common elements within the first processes to provide an estimated process flow; evaluating an identified process to determine an absence of one or more element common to the estimated process flow; and providing a notice of the absent element.

In accordance with embodiments of the invention there is provided a method comprising: analysing a data set to determine different instances of first processes reflected thereby; determining common elements within the first processes; forming a first process definition based on the determined common elements and an ordering thereof; providing the process definition including a list of process steps and data associated with each step; evaluating an identified process to determine a location of a process within one or more process flows; and providing a reminder indication relating to an upcoming element within the one or more process flows.

In accordance with embodiments of the invention there is provided a method comprising: analysing a data set to determine from a number of processes common elements forming part of a first processes; mapping the common elements within the number of processes to provide an estimated process flow for the first process; evaluating an identified process instance to determine an absence of one or more common elements common to the estimated process flow; and providing a map of the identified process instance flow relative to the estimated process flow and indicating events and documents forming the number of processes.

In some embodiments the map includes a mapping of an identified process onto the estimated process flow.

In some embodiments the mapping includes an indication of deficiencies within the process flow.

In some embodiments the mapping includes an indication of where within the estimated process flow, the indicated process is currently.

In accordance with embodiments of the invention there is provided a method comprising: analysing a plurality of data sets to determine, from a number of process instances, second common elements forming part of a second process definition relating to at least a second process flow for a second process; mapping the second common elements within the number of process instances to provide the second process flow for the second process; evaluating data to extract a second unidentified process; mapping the second unidentified process against the second process flow and when the second unidentified process is a potential match against a first portion of the second process flow, determining an absence of one or more common elements common to the second process flow; and providing a map of the second process flow indicating events and documents forming part of the second unidentified process within the second process flow.

In some embodiments the mapping includes an indication of where within the first estimated process flow and within the second estimated process flow, the indicated process is currently.

In some embodiments the method comprises displaying a process element within the first estimated process flow that is absent from the second estimated process flow, the displayed process element distinguishing the identified process from being part of the second estimated process flow.

In accordance with embodiments of the invention there is provided a method comprising: analysing a data set to determine common elements within similar processes, the common elements forming the similar processes; and providing a map of the similar processes indicating events and documents forming the similar processes and highlighting at least one of an event and a document absent from at least one of the similar processes.

In accordance with embodiments of the invention there is provided a method comprising: analysing a data set to determine common elements within similar processes, the common elements forming the similar processes; providing a map of the similar processes indicating events and documents forming the similar processes; manually modifying the map of the similar processes to eliminate some common steps or documents within the similar processes; and storing data indicative of a modified process comprising an indication of events and documents forming the similar processes as edited.

In some embodiments, the method comprises analysing a data set to determine common elements within the similar processes; and highlighting at least one of an event and a document within the modified process and absent from at least one of the similar processes.

In accordance with embodiments of the invention there is provided a method comprising: analysing a data set to determine common elements within similar processes, the common elements forming the similar processes; and providing a map of the similar processes in a form for training individuals in the process.

In accordance with embodiments of the invention there is provided a method comprising: determining a process map for a plurality of different processes and, during current process execution, mapping the process to each of the plurality of different processes for which the current process remains compatible.

In some embodiments, the method comprises reminding an executor of the current process of potential upcoming events, the potential upcoming events dependent upon which of the plurality of different processes are potential processes for the current process.

In some embodiments, the potential processes for the current process are determined by requesting that a user filter potential processes.

In some embodiments, the potential processes for the current process are determined by requesting that a user filter potential processes and by filtering potential processes that do not share process events that have already occurred within the current process.

In accordance with embodiments of the invention there is provided a method comprising: providing a process definition including a list of process steps and data associated with each step; analysing a data set to determine first elements common to a same instance of the first process; mapping the common elements within the same instance of the first processes to provide an estimated process instance flow; comparing the common elements against a ground truth; filtering the common elements to elements correlating in dependence upon the ground truth to limit common elements to those that confirm the ground truth and common elements relating to ground truth for which there is no confirmation; evaluating the estimated process instance flow to determine a ground truth absent confirmation; and displaying the ground truth absent confirmation and the common elements relating thereto.

In accordance with embodiments of the invention there is provided a method comprising: providing a process definition including a list of process steps and data associated with each step; analysing a data set to determine first elements common to a same instance of the first process; mapping the common elements within the same instance of the first processes to provide an estimated process instance flow; filtering the common elements to elements best correlating with the process instance flow to limit the common elements to filtered common elements; and evaluating the estimated process instance flow to identify based on the filtered common elements common elements that are one of absent and incorrect.

In accordance with embodiments of the invention there is provided a method comprising: providing a plurality of process definitions; extracting from a data set elements common to more than one of the plurality of processes; and providing an indication of the more than one of the plurality of processes to a user.

In accordance with embodiments of the invention there is provided a method comprising: analysing a data set to determine common elements within similar processes, the common elements forming the similar processes; providing a map of the similar processes indicating events and documents forming the similar processes and highlighting at least one of an event and a document absent from at least one of the similar processes.

In accordance with embodiments of the invention there is provided a method comprising: analysing a data set to determine common elements within similar processes, the common elements forming the similar processes; providing a map of the similar processes indicating events and documents forming the similar processes; manually modifying the map of the similar processes to eliminate some common steps or documents within the similar processes; and storing data indicative of a modified process comprising an indication of events and documents forming the similar processes as edited.

In accordance with embodiments of the invention there is provided a method comprising: analysing a data set to determine common elements within similar processes, the common elements forming the similar processes; providing a map of the similar processes in a form for training individuals in the process.

In accordance with embodiments of the invention there is provided a method comprising: determining a process map for a plurality of different processes and, during current process execution, mapping the process to each of the plurality of different processes with which the current process remains compatible.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 illustrates a simplified methodology of a traditional business process audit according to prior art.

FIG. 2 is a simplified diagram of an example of a Data-Driven Business Process model.

FIGS. 3A, 3B, and 3C (also referred to as FIG. 3) is a simplified example of a Data-Driven Business Process model as used in a traditional audit based on a source ledger. In this traditional audit the source ledger is considered the primary source of truth.

FIGS. 4A, and 4B (also referred to as FIG. 4) illustrates a simplified example of table joining, both inner and outer.

FIGS. 5A and 5B (also referred to as FIG. 5) is a simplified diagram of a methodology for the creation of a data-driven business process model through purpose-driven build process.

FIG. 6 is a simplified diagram of a methodology for a financial analysis or audit, wherein the source ledger is not the primary source of truth.

FIG. 7 is a simplified diagram of a methodology for the detection of source ledger issues or omissions, based on a financial analysis or audit, wherein an alternative primary source of truth is established.

FIG. 8 is a simplified methodology for the use of a data-driven business process model (DDBPM) and applied fuzzy logic in detecting subtle source ledger and data source variances and anomalies.

### DETAILED DESCRIPTION OF EMBODIMENTS

The following description is presented to enable a person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed but is to be accorded the widest scope consistent with the principles and features disclosed herein.

### Definitions

Data Element: Data elements are meaningful segments of information logically identifiable but not necessarily constrained by a one-to-one relationship to a traditional file. It is possible for a data element to be an entire file, such as an invoice. However, at times data elements may also be notable sub-segments within a file. For example, an email archive file is a single file. It could be considered a data element. Similarly, that same email archive may contain many data elements in the form of emails some of which in turn each may contain additional data elements. Where they are embedded within a file or container, a data element may also be referred to as a data field.

Data-driven Process Model (DDPM): a means of defining a series of steps forming tasks based on the changes in state or transformations, that data goes through at each step. It is a process modelled around a known set of document classes, where at each step one or more of these document classes is associated with the process. Specifically, the documents are created, modified, touched, read, altered, consumed, destroyed, or have some other direct or indirect interaction with a task in question.

Modeled Business Process: a means of representing activities which are undertaken by an enterprise in their normal course of business operations. It includes a representation of the flow of a process, outlining steps taken in executing the process. A modeled business process includes a representation of the order of these steps, their dependencies, and their interrelationships. It also includes modeling and representation of data associated with these steps. This includes, the data and documents created, consumed, referenced, updated, or destroyed for each step in the process or involved in the process overall. A completely modeled business process identifies and includes representation of the informational segments, data fields, within each of the documents associated with the business flow.

Data-driven Business Process Model (DDBPM): a DDPM where the process being modeled is directly associated with a well-known business task or audit flow, e.g., a sales cycle.

Field Chain: a set of data element fields of document classes that are collectively associated with one another in a known and consistent relationship. The fields in the chain are commonly available in each of the document classes that participate in the chain. One document class within the chain is said to be the anchor it is a reference value by which all the other classes are arranged/chained.

Supradata: supradata is a combination of at least some of metadata regarding a data element. In addition to traditional metadata it includes actions, transformations, and relationship elements that are stored in a time varying fashion such that metadata is appended to previous metadata instead of overwriting same to form a present, historical, and continuously deepening metadata data set. In addition, supradata includes context regarding the data element. The context may give reference to the origins of the data, the purpose of the data, or the contents of the data. Some context also includes actions on, interactions with, associations, and relationships with other data elements within a data set. By example, a PDF contract file may include a link to the email to which it was attached when it was delivered, which in turn contains a link to the email archive from which the email was extracted all within the current or some other external data set.

Table Join: is a common database term referring to the merging of two separate tables, a first table and a second other table, into a resultant third table, which includes information from the two separate tables.

Inner Join: is a common database term referring to a join of two or more tables where all rows are included from the constituent tables when there is at least one common column with which to match and the values in the common column(s) match by some specified criteria. Omitted are rows where the common column values do not have matching values.

Outer Join: is a common database term referring to the merging of two separate tables, a first table and a second other table, into a resultant third table. The two constituent tables must have at least one or more common column(s). In an outer join, all rows are included, even where the common column(s) have values which do not align.

A financial audit is a mechanism where an organization can validate that it is carrying out business with a financially valid methodology. It evaluates the business processes involved in the day-to-day operations of the organization to ensure they are structured, controlled, and executed correctly in support of the successful achievement of the business and financial goals of the organization. A financial audit ensures such operations are carried out within the boundaries established by internal risk management and governance and external law and regulation. It establishes the trustworthiness of the organization's financials, validating their business processes and verifying the organization's books.

In the world of enterprise finance and financial audit in particular, the GL is considered the primary source of truth for the corporation. This means that any financial audit of the corporation begins with and is based on the GL and its corresponding sub-ledgers. They are considered the fact-based, official financial corporate record. This is a proven and widely accepted contemporary business norm.

Audits, therefore, become predominantly verifications of the GL and its sub-ledgers, in the context of the business processes of the enterprise. Several other factors are also considered such as the risk profile, governance, and regulatory environment. Based on these criteria, supporting documentation and evidence is gathered to determine the veracity of or issues with the ledgers under review.

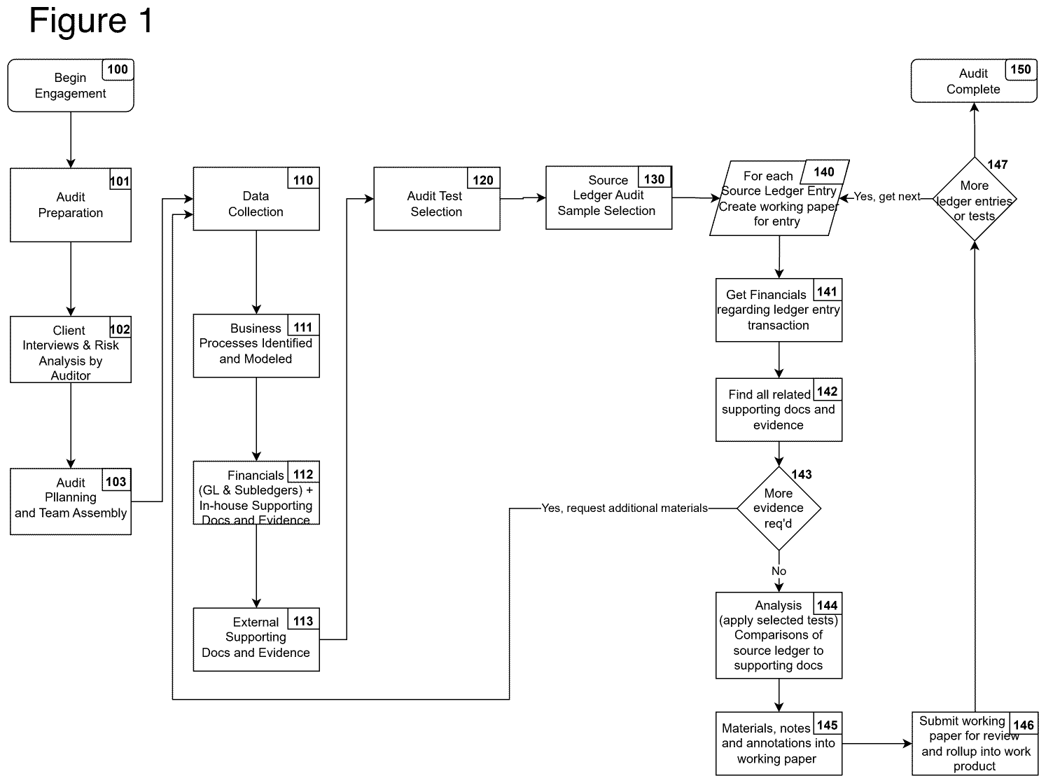

Referring to FIG. 1, what is shown is a simplified methodology of a traditional business process audit. The audit begins at 100. Historically, a large part of the effort in such audits, is focused on the data collection, starting at 110. Another heavy lifting portion of the audit is during the individual audit tests, at 140. Finding the appropriate associated documents, as at 142, is predominantly a manual process performed by the audit team. As shown at 143, it may also entail going back to the client organization to request and garner additional information. Such manual processes have limitations and are subject to human error or accidental omission. The volume of information continuously being generated by organizations is in most cases increasing, exacerbating the problem. This makes for an intractable manual data coverage challenge.

To address this challenge the current state of the art takes two forms, enforcement and discovery. In the enforcement model, the key supporting documents are expected to be loaded into a secure repository through the same tools that manage the financial books, statements, and the GL; effectively bundling together the document collection with the business processes. The second form, discovery, is essentially the manual process describe above.

It would be advantageous to have the means whereby the business processes being audited, and their supporting documentation can be consolidated in a manner that reflects reality and information completeness, but remains separate from the GL, providing better evidence to compare with the GL from an audit perspective.

For example, a complete set of financial records remains subject to intentional fraud. An employee could enter fraudulent invoices that get paid by the company for fictional services that are never rendered. Such a fraud is difficult to uncover when properly executed. Even more problematic are similar such frauds executed by contractors and included within invoicing as disbursements or other charges. Because the invoices and payments are “consistent and complete,” the information to “audit” these charges properly is not within the GL, but instead rests in other business processes and communications.

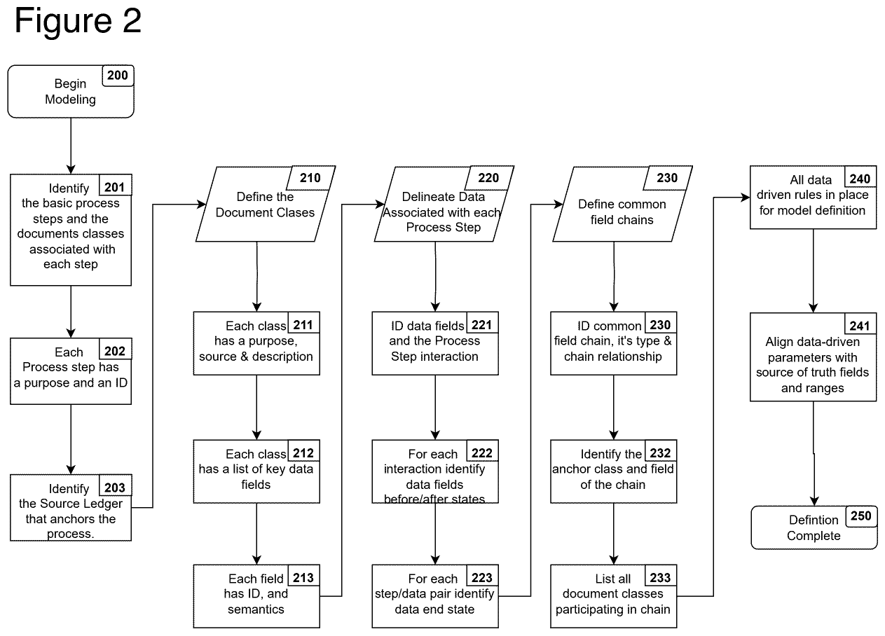

Referring to FIG. 2, what is shown is a methodology for creating data-driven business process models (DDBPM). The data-driven business process model still has, at its core, the basic steps of the model. These and the corresponding classes of documents that are associated with the model are defined at onset 201. The list of document classes are classes of documents that are involved or associated with the process or relied upon or referenced along a process path. Without limitation, being associated with a DDBPM, at a minimum, includes that a document is any of, created, read, opened, closed, updated, written to, deleted, or its presence or status is checked.

In most cases a business process is also associated with a source ledger. This is often the general ledger (GL) or one or more of its subledgers. However, the source ledger is optionally any table of transactions that the process delineates.

Document classes that correspond with the various process steps are also defined, as at 210. A document class has a common relationship, wherein each document in a class shares a set of data elements. These data elements are fields that are common to all members of a class. Each field has a specific field identifier and has its own semantics. The semantics define the way in which data within a field is interpreted. For example, a data type, optionally a range or set of allowable values, optionally a range or set of invalid values, and whether or not the field is required or optional in this particular business process model. Further a data type, such as date, might also vary in form or format depending on its origin, for example with dates from the USA being month/day/year and from Europe being day/month/year.

For example, a document class is proposals. The class purpose is documents that offer a sales business agreement. The class may share common fields of customer ID, effective date, delivery address, signature block, and total cost, where customer ID is an alpha-numeric string, effective date is a calendar date in the format (MM/DD/YYYY), the delivery address is a multiline set of strings defining a brick and mortar address of the customer site to which the product will be delivered, the signature block either shows as someone has signed off or not, and total cost is a fixed point number with two decimal spaces and in US dollars. Various documents have other fields, like items, quantities of items, unit costs, extended costs, and delivery instructions and are considered as members of the proposals class, so long as they have the common fields, and they have a purpose of being an offered sales business agreement.

As shown at 220, for each step in the identified business process the document classes associated with the step are defined in a model. In particular, as at 221, either the whole document or specific fields from the document classes are identified as being associated with the business step. This is also where the type of association is identified for the document class, for example, was it created in this particular process step. In some, but not all, instances it may be more specific to identify the before and/or after step states of fields and documents in question. For example, in the proposals class above, a customer agreement to do business completes an “accepted” process step if there is both an effective date and a signature in a signature block(s). It should be noted that the source ledger is itself a special case of a document class where fields are in tabular form.

At this stage, approaching step 230 in the methodology, all of the puzzle pieces have been identified in the model; the process steps, the document classes associated with the process, and the specific fields within the classes and how they are associated with the process and its sets are defined. Now, in a DDBPM it is important to understand how all of the data elements fit together, how the puzzle pieces connect. The connectivity or inter-relationship of document classes is identified by field chains.

As defined above, a field chain is a set of data element fields of document classes that are collectively associated with one another in a known and consistent relationship. The fields in the chain are commonly available in each of the document classes that participate in the chain. One of the document classes within the chain is said to be the anchor. It establishes the reference value by which all the others are arranged/chained based on their relationship in the chain. For example, in a sales cycle process, an important field chain is the customer ID. Most, if not all, of the document classes involved with the sales cycle, including the source ledger, will have a field defining the customer ID. In this case the relationship is equals. For all document classes in the process, for a specific step in the process, documents in that class which have the same customer ID as the anchor class customer value, will be associated with the same transaction, driven from the anchoring source ledger. Alternatively, there is a customer ID and a transaction process ID such that the system supports a single customer having multiple sales processes running simultaneously. If they all have that customer ID they are all associated with that transaction. It is possible for a DDBPM to have multiple field chains, defining the changing relationships between document classes from step to step or amongst one another within the same step.

At 240, the last pieces are in place, including the field chains. As previously alluded to, all document classes including the special class of the source ledger are potentially part of a same field chain. For the process model to have focus, it typically references a primary source of truth. This is the document class which is deemed to be “correct” and is presented as the standard by which the rest of the process and surrounding data classes are measured. The identification of the fields in this primary source of truth complete the model definition, as at 250.

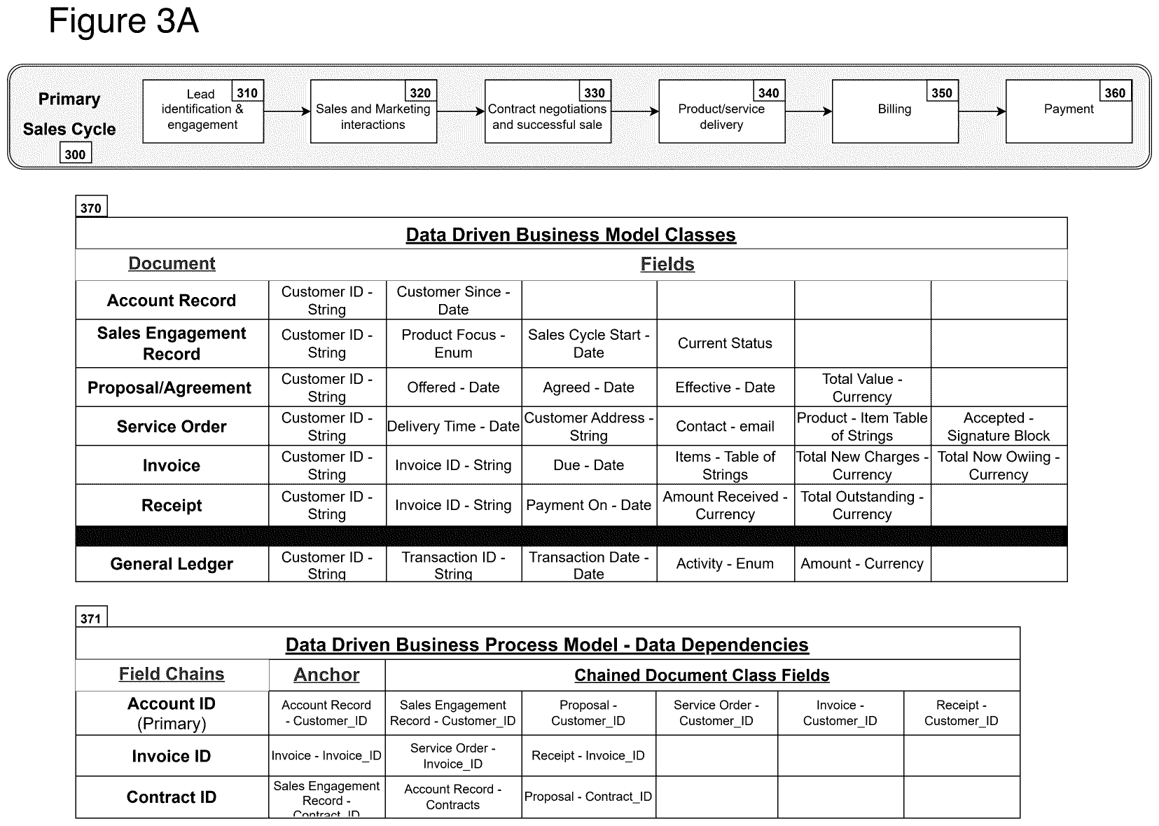

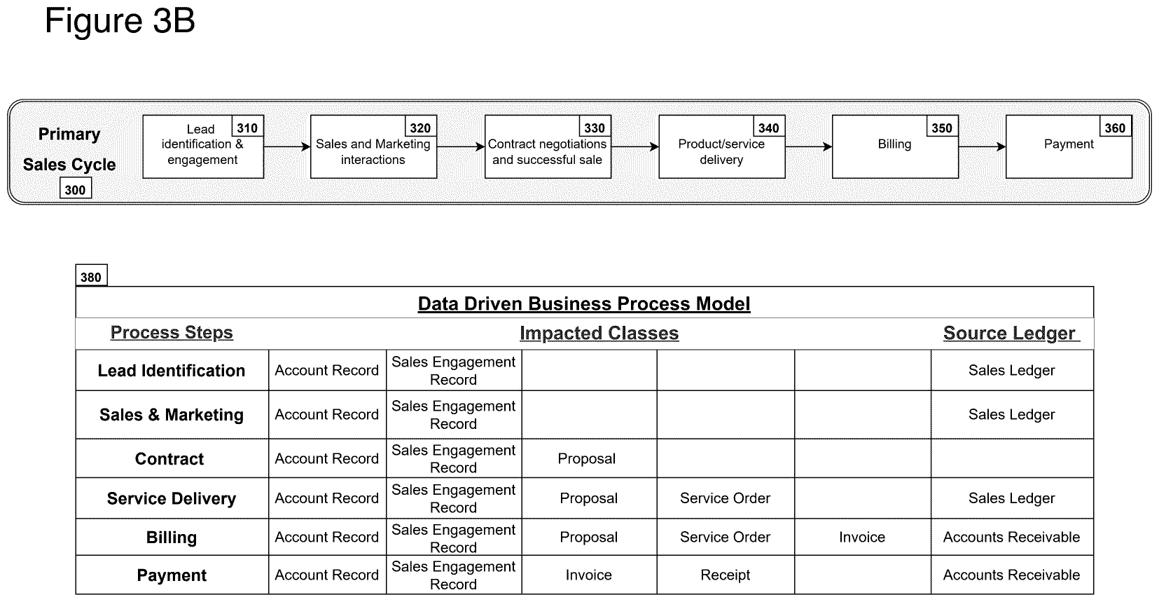

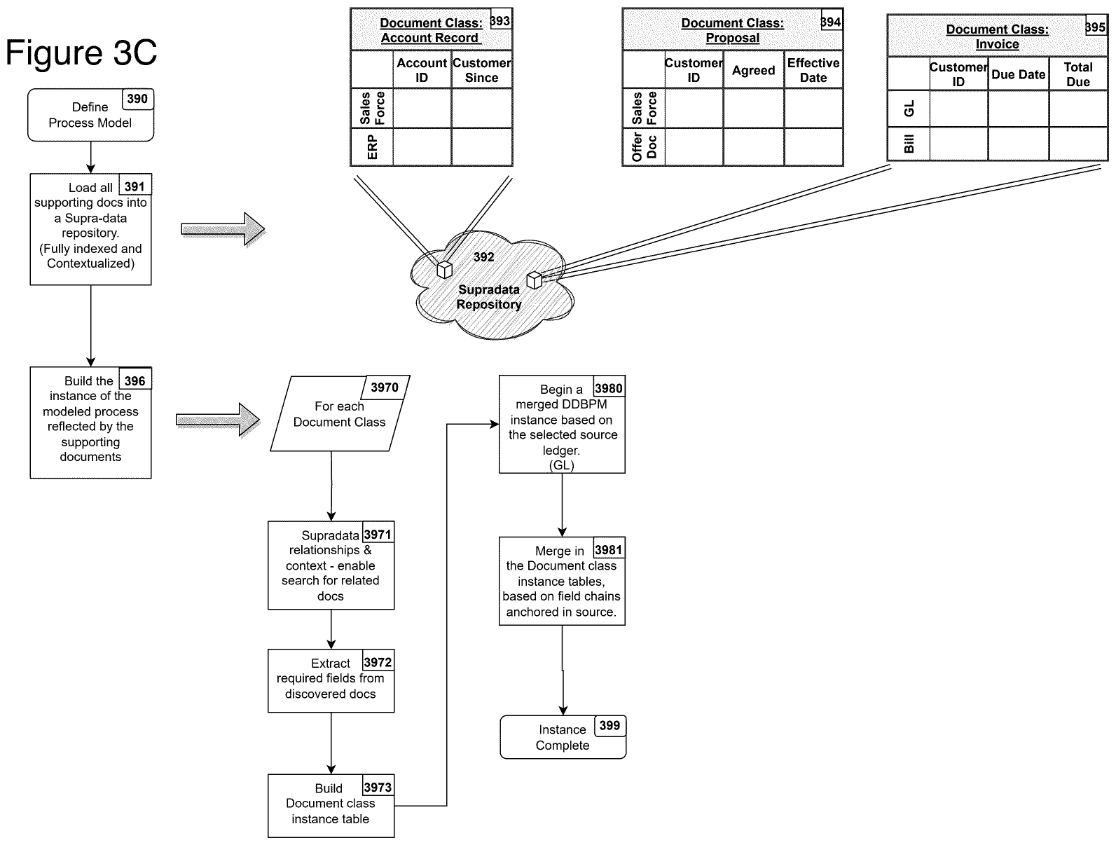

Referring to FIG. 3, what is shown is a data-driven business process model as applied to the traditional audit process from FIG. 1. In this application of the model the primary source of truth is the source ledger. In FIG. 3a, the modeled process is illustrated showing an exemplary sales cycle. Process Steps are defined, at 300, running from 310 through 360, and the Document Classes and their required fields are defined, as represented by the table at 370.

The table at 370 is also augmented with the field chains that describe the document class interlinkage. Illustrated by the table at 371, in the case of this example, the primary field chain would be the Customer ID, which occurs in one form or another in all of the document classes. This is anchored by the Account Record document where the Customer ID is created. A secondary field chain is the Invoice ID field, which occurs in both the Invoice and Receipt Document classes. Theoretically, it optionally occurs in the Service Order class. This chain is anchored by the Invoice document class, as this is where the Invoice ID is created. Other chains and inter-dependencies are supported within the model.

FIG. 3b, completes the data-driven business process model by mapping the Document Classes to the process steps, as shown in the table at 380. This table also maps the process steps to the corresponding source ledgers, which are subledgers of the General Ledger (GL). A more fully detailed version of this model includes the specific fields of relevance from the document classes for each process step and the way in which these fields are related to the process step. For example, the Invoice ID field is created at the Invoicing step but relates to the invoicing, payment and with hindsight to the initial request and quote.

FIG. 3c, illustrates how the use of fully contextualized repository—Supradata repository—automates discovery of related documents and encapsulated data elements they contain as they pertain to an instance of the modeled business process. The methodology begins with the definition of the DDBPM, the process model, at 390. To ensure a complete picture of the business process as operated in the organization under audit, the available supporting documentation is loaded into a supra-data repository, at 391. This repository provides a unified source of documents from across silos of the corporation, in a manner which both indexes and contextualizes the documents within it. In this manner, the repository offers a searchable source of the supporting documentation and evidence for the audit. Alternatively, documents remain where they are and the supra-data repository includes indices to the documents and document locations.

To build the instance of the DDBPM, beginning at 396, the methodology proceeds

by building out the individual document classes as defined in the model. For each class, the context and searchability of the supradata repository enables the discovery of all documents which are in this class. They are collected together at 3971. For each document in this resultant class set, the necessary data elements, the fields of interest to the model, are extracted and tabulated in the document class instance table, at 3973. This continues class-by-class until all associated classes defined in the model have been populated.

With all of the class instance tables populated, the integrated model instance is formed. Since the primary source of truth in this case is the source ledger, the ledger fields/columns form the basis of the model instance table. It is the source table. This table is then expanded upon, based on the progression of process steps and the relative data elements from the associated document class instance tables. Merging the document class instance tables proceeds with row matching based on the field chains as defined in FIG. 3a, at 371. Where possible or where there is conflict, priority is given to the primary source of truth, the source table columns. Alternatively, where conflict exits, priority is given to a human arbiter of truth who selects the most reliable “source of truth.”

At 399, the DDBPM instance is fully populated, reflecting the source ledger and all of the appropriate values from the supporting documents and evidence. The insights yielded by the integrated instance offer a much improved and accelerated analytic foundation over traditional audit which collates the data manually. Based on the DDBPM instance, the auditor has all of the corporate information directly at hand and pre-associated with the transactions to which they pertain. This powerful and insightful audit methodology is only enabled by the combination of a supra-data class repository and a Data-driven Business Process Model (DDBPM).

The preceding DDBPM instance is a valuable tool for audits both in verifying correctness and in detecting issues and anomalies in the implemented business practices of the organization under review. However, if there are issues with the data used to build the model, it may not come together as cleanly as outlined in FIG. 3. Therefore, it is necessary to provide a mechanism to construct the DDBPM instance in spite of flawed data.

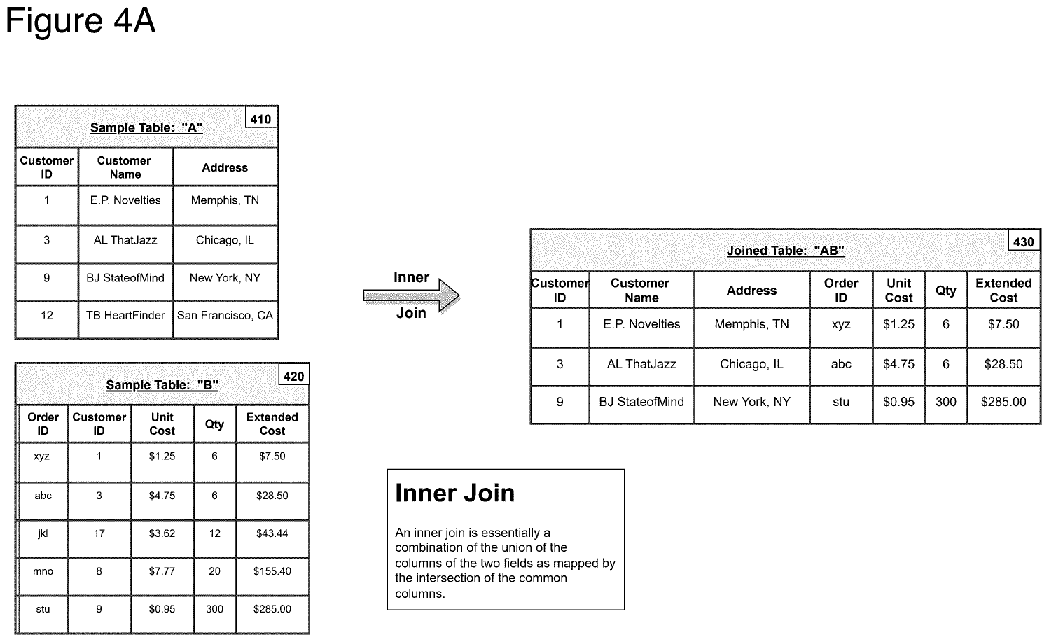

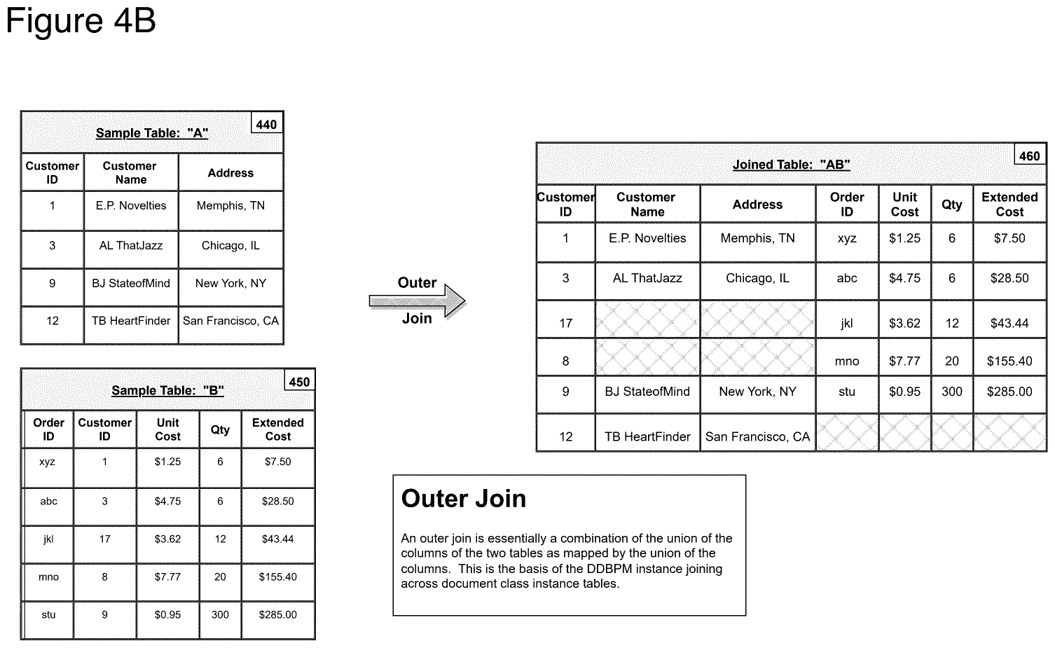

Referring to FIG. 4, what is shown is an illustration of table joining for the combination of structured or semi-structured data in a repository. These techniques are well known for those skilled-in-the-art. FIG. 4a, illustrates an inner join. An inner join reflects, an intersection of two contributing tables. As with a DDBPM there is a primary field chain; a common field shared between the two tables. With an inner join, the rows of the resultant table reflect the fields from both tables where there is overlap or matching between the values in the shared common field. In simple terms it is the intersection set of the rows. In the example of FIG. 4a, Tables “A”, at 410, and “B”, at 420, have the common field Customer ID. The rows in the resultant joined table, at 430, are only those rows where the Customer ID field matches between tables A and B. In a DDBPM these common columns can be the field chains previously discussed.

FIG. 4b, illustrates an outer join. An outer join reflects, a union of the two contributing tables. As with a DDBPM there is a primary field chain; a common field shared between the two tables. With the outer join, the rows of the resultant table reflect the fields from both tables regardless, whether or not there is overlap or matching between the values in the shared common field. In the example of FIG. 4b, Tables “A”, at 440, and “B”, at 450, have the common field Customer ID. The rows in the resultant joined table, at 460, are both those rows where the Customer ID field matches between tables A and B and those where there is a unique value in either table but not the other.

Applying these techniques when building a DDBPM instance as previously described can lead to additional and heretofore unknown insights. Each of these outlined join techniques can be applied to an imperfect DDBPM instance to aid in completing the model and yielding additional information in the process.

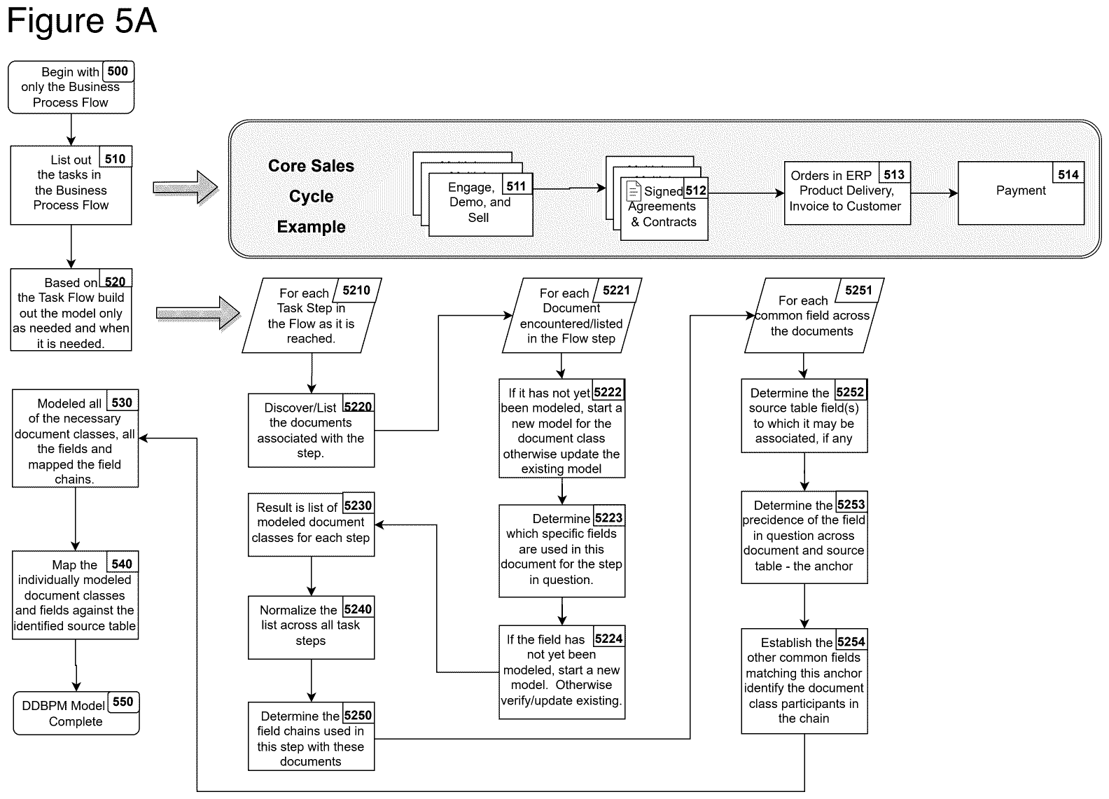

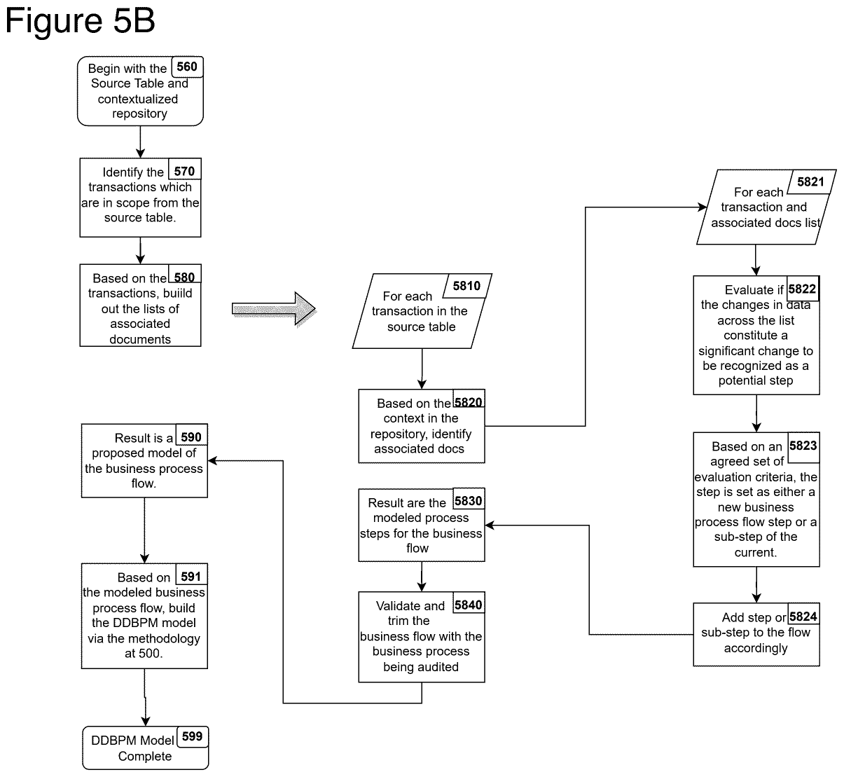

An embodiment allows for the Purpose-Driven building of the DDBPM. It does not require advance knowledge of the models for either the document classes or the DDBPM. Referring to FIG. 5a, what is shown is a simplified methodology for the purpose-driven creation of the DDBPM. In this version of the methodology, the business process is known and is well understood. The steps of the business process flow are known in advance, but the rest of the model is not. This is most often the case in a traditional financial audit. Though the model of the DDBPM is not yet known, it is buildable from associated documents and evidence. Starting at 520, with the business process flow mapped at 510, the rest of the model is built on a task-step-by-task-step basis. As the audit proceeds and each business process step in the flow is encountered, at 5210, a list of documents and evidence associated with that step is identified, at 5220. For each of the encountered documents associated with the process step, as shown at 5221, the modelling is deepened by the modeling of the enclosed document fields which are involved in the process step being modeled. In each of these modeling cases, if the document class did not previously exist, then a new one is created, otherwise the existing one is updated, as at 5220. The same process is relied upon for modeling fields within the modeled document class at 5224.

At 5240, all of the encountered document classes and their corresponding data element fields are modeled across all of the steps in the business process. It should be noted that the resulting models are minimalist, representing only those elements encountered in the flow. Other document classes or fields within document classes optionally exist in a fully comprehensive model of the process but they hold little to no relevance to the process under audit.

Following the modeling of the relevant documents and fields to the process, the next step, as shown at 5250, is to build out the relationships between the document classes. This is modeled by building out the primary and secondary field chains as perceived in the model, at 5251. These field chains are based on fields that are common across two or more documents in the model (including the source table). Typically, the field with the highest degree of commonality across the most document classes, is determined to be the primary chain. Typically, the rest are secondary.

When modeling the field chains, what is needed is the list of document classes where the common field occurs, and each name of the common field within those classes, the chain. Each chain typically has a designated anchor. At 5253 the anchor, the document class with the highest precedence for that field, is determined. Most often the anchor is the document class wherein the data element is created/populated, quite often a source of truth for that field. The rest of the fields are mapped to the chain model as at 5254.

For example, consider the secondary chain based on Invoice ID field that is utilized in several classes including, the source table, an invoice class, service orders, and receipts. Its anchor is either the invoice class or the source table depending on where the invoice class is generated.

Once the document classes have been modeled, their enclosed data element fields have been modeled, and the relationships between them have been mapped, all as they fit within the business process flow, they are also mapped against the source table or ledger, as at 540. With this the data-driven business process model has been built.

Using this methodology, the DDBPM is truly data driven and does not require the model be built out and specified in advance of creating the first instance. The steps outlined are optionally undertaken in advance or optionally undertaken directly as the system is stepping through the model to create an instance for analytic or audit purposes. In this manner, the audit process is significantly simplified and accelerated doing only what needs to be done when it needs to be done.

Referring to FIG. 5b, what is shown is a simplified methodology for the creation of a data-driven business process model where the business process itself is not necessarily well known and is developed, on-the-fly based on discovered documents that are used to implement it. A real-world example of this situation would be when the organization being audited has introduced a new or modified business process.

The methodology outlined in FIG. 5b can be simplified with the presence of a contextualized repository for the associated documents, a supradata repository. Such a repository shows associations and relationships between documents provided in support of the business processes and as evidence of their results, in support of the audit in question. In FIG. 5b, the source table or ledger comprising transactions from the corporate general ledger or one of its subledgers is known, as it is being audited. Starting at 570, key transactions in scope for the business process being audited are identified. This essentially delineates specific rows of a source table that are in scope. Based on these transactions and the data contained within these rows, at 580, the supradata repository, its indexing and contextual associations, are used to map out documents related to the transaction, as at 5820. For example, a service is sold to the customer, this is reflected by a single transaction in the sales ledger. This transaction contains the Account ID of the customer, their contact information, perhaps the service address, the service sold, and the selling price. It likely also contains an invoice ID referencing the bill sent to the customer for the transaction. Based on this information, querying the supradata repository would yield the following related documents: the source table/ledger, all of the documents associated with the account ID of the customer, all of the documents associated with the invoice ID. It would be a superset of the documents associated with the transaction. With a little analysis, this superset can be resolved down to the directly relevant set of documents, for example documents not associated with the target service or address could be eliminated from the list of documents associated with the customer, leaving the transaction specific relevant documents.

By examination of the transaction and the documents related to the transaction, the breadth and impact of the transaction is assessable. In the sale transaction above, the customer agreeing to the service at a given price is a significant business step. Whether or not the step is a subtask of a larger, more significant task in the process task flow is relative to the organization, the process, and to a degree the transaction being audited. For example, if the sale was a $0.10 candy, that is likely less significant or impactful than the sale of a $50,000,000 medical device. However, with the related documents and the transaction record, at 5823, based on pre-determined criteria the decision as to the degree of business impact and therefore the business assessment of which level of task the step represents is determined. With this determination, the step is added to the business process flow. Optionally the resulting business process flow is verified or validated as a component of the analysis. By 590, the full business process flow model has been constructed based on the evidence supplied. It is then used according to the methodology outlined in FIG. 5a to develop the full data-driven business process model from the ground up.

Those skilled in the art could also anticipate a similar methodology where the discovered documents are used as the primary key and the transactions with which they are associated can be used to identify the corresponding source table as well.

Since the purpose-driven methodology does not require advance knowledge of the data-driven business process model several real-world benefits can be realized. The amount of training required by an analyst to build a model that yields actionable insights is often minimized. By extension, where a contextualized data repository is in service, the building of the model is optionally automated, utilizing supervised applied machine learning. In this manner, the intractable task of modeling and training for the modeling of business processes in an audit is resolved. Likewise, the audit itself is accelerated.

The processes outlined in FIG. 5 set the foundation for DDBPM. With a DDBPM and the provided data the analyst/auditor has sufficient information to execute a traditional business process audit. Similarly, based on the same foundation, the evidentiary data can be considered as an alternative primary source of truth to validate the source table/ledger offering a more robust and effective audit.

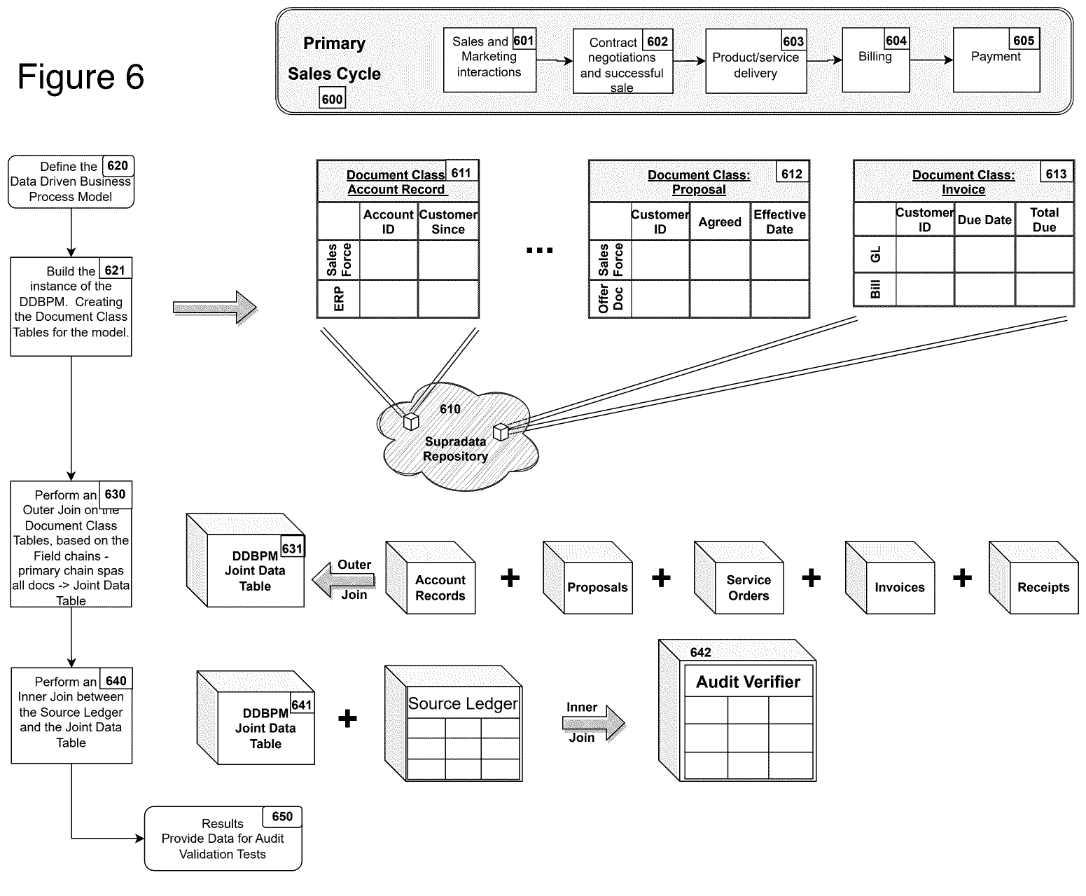

Referring to FIG. 6, what is shown is a method whereby a data-driven business process model (DDBPM) is combined with automated document discovery and data element extraction to produce a semi-structured set of DDBPM data element values. Based on the sample business process of a simplified sales cycle, shown at 600, using the defined data-driven business process model, at 620 and optionally a contextualized supradata repository for the supporting and associated documents, at 610, an instance of the DDBPM is populated. The involved and associated document classes each build out into tables reflecting the documents discovered, the repository, and the field values for each of the requisite process steps. These would be tables of document classes, such as seen at 611, 612, and 613. When these semi-structured data element tables are appropriately joined, specifically outer joined as per FIG. 4, with each other as per the model in the DDBPM but not with the source table, the result is an instance of the DDBPM that forms an alternative source of truth, as per 630 and shown at 631. Because the DDBPM Joint table is an outer join, it is the union of the constituent tables omitting none of the supporting data. This makes it a fully comprehensive source of truth based on provided evidence and supporting documents, though it may still be missing some source documents that are not available or are not within the datasets.

At 640, an inner join is performed merging the DDBPM Joint Table with a source ledger being audited. Said another way, the document classes and their values are aligned with the source ledger. As an inner join, based on the ledger as anchor, the resultant table, at 642, shows the supporting data for all transactions from the ledger that are in scope. This makes for an excellent platform, at 650, for the accelerated application of various verification tests and analytics, such as a sample test of details. Such a consolidated platform, particularly one that is generated through applied machine learning and automation is highly advantageous, making for an accelerated dataset for audit analysis across a significantly larger data, with fewer errors and manual tasks.

Similarly, this new source of truth generated at 631 is useful to elicit further insights. Consider results of the inner join performed at 640 the anchor is the alternative source of truth, the supporting data instead of the ledger. Now the table at 642 shows only those entries that align to the source data-not the ledger. Therefore, it is useful in an audit to find issues from and/or within the source ledger. Essentially, with the source ledger as the GL or its subledgers, the audit process is somewhat reversed and enhanced.

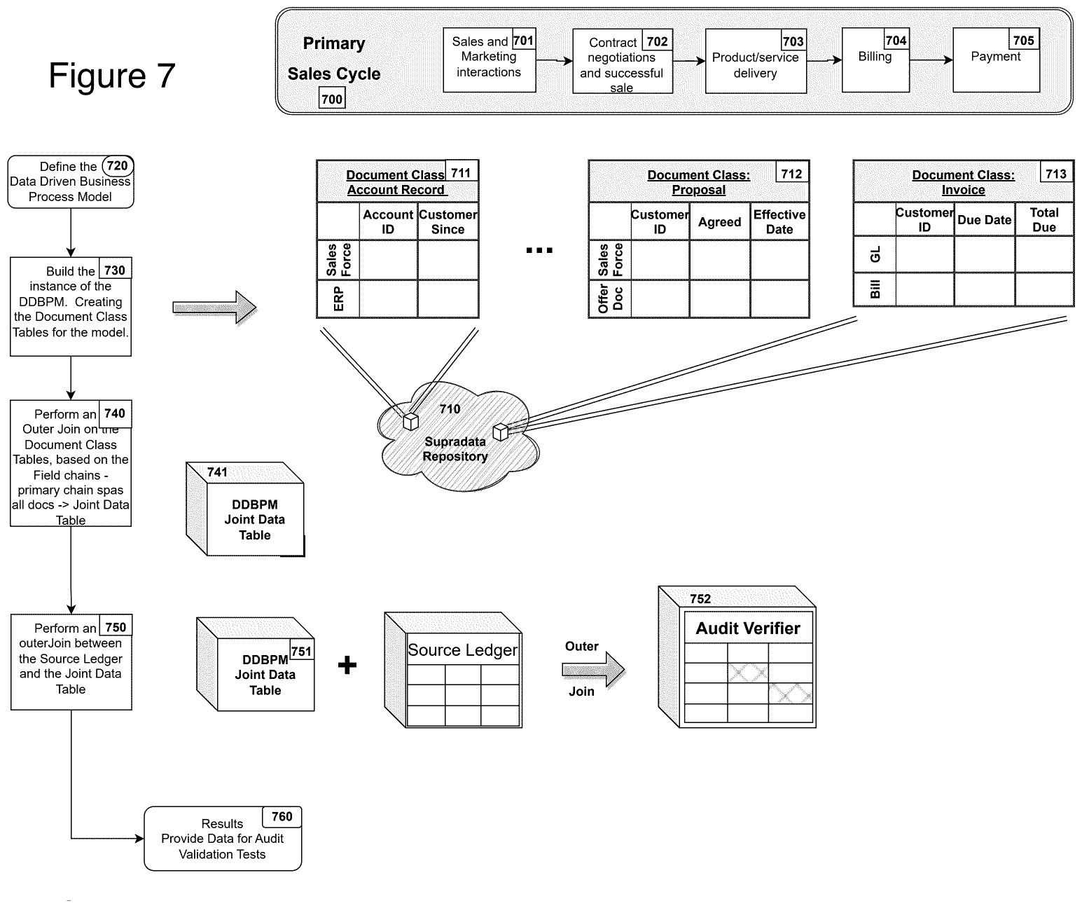

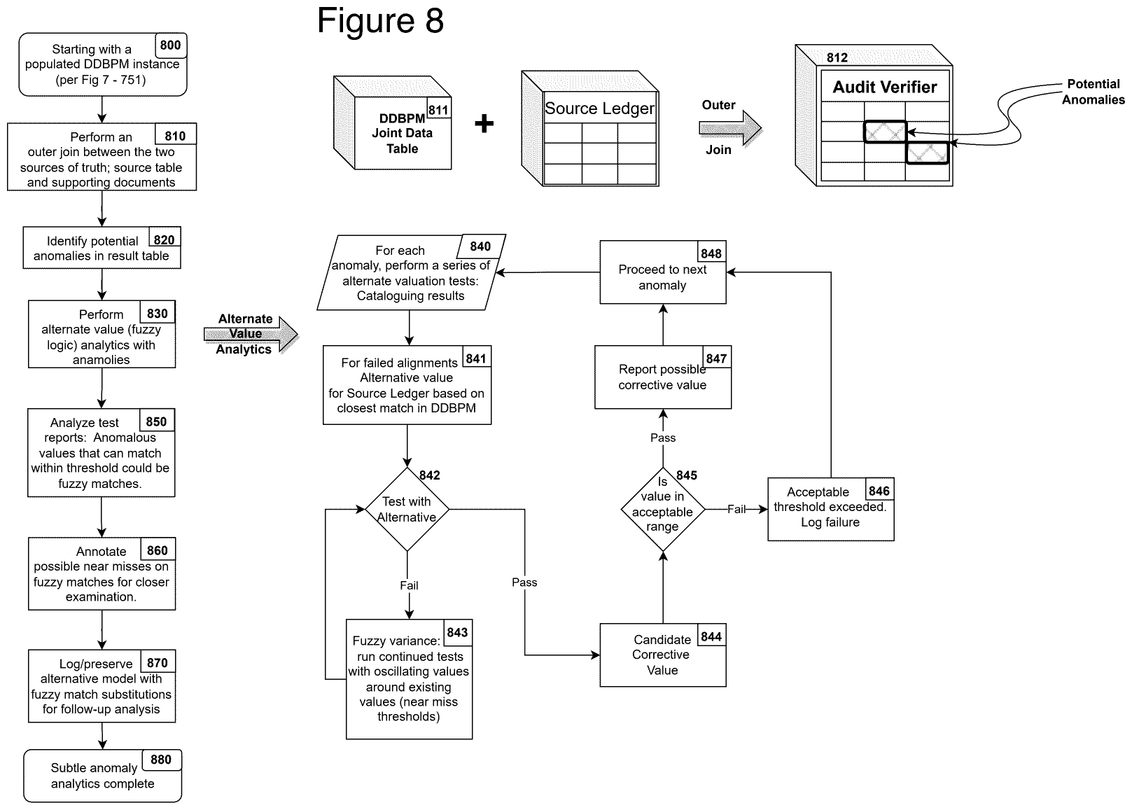

Referring to FIG. 7, what is shown is a method whereby errors and omissions in the GL or corresponding subledgers are determined based on a DDBPM-driven alternative source of truth audit similar to that described with reference to FIG. 6. The difference in the methodology is at step 750. Instead of performing an inner join of the two sources of truth, an outer join is used. Therefore, the table at 752 is the union of the two sources of truth. The table has rows that are sparse, or with a few missing cells. Such imperfect alignment is insightful, identifying gaps or errors in either the source table/ledger or in the supplied data. Tests of completeness would benefit from such a base source of analytic data. In situations where one table or the other is completely empty for the row in question, it is indicative of omissions potentially in the source ledger or of ledger entries where no data is found in support of the transaction.

It is advantageous that this entire process be automated or semi-automated, and the evaluation of the results produced at 760 yield more insights than a completely manual audit. In some embodiments, the resultant tables are further evaluated by applied supervised machine learning.

Numerous other embodiments may be envisaged without departing from the scope of the invention.

What is claimed is:

1. A method comprising:
providing a first process definition including a list of process steps and data associated with each step;
analysing a data set to determine first elements common to a same instance of the first process;
mapping the common elements within the same instance of the first processes to provide an estimated process instance flow;
evaluating the estimated process instance flow to determine an absence of one or more element common to the process definition; and
providing a notice of the absent element.

2. A method according to claim 1 wherein providing comprises:
analysing the data set to determine different instances of a same first process reflected thereby;
determining common elements within the different instances of the first process;
forming a first process definition based on the determined common elements and an ordering thereof; and
providing the first process definition including a list of process steps and data associated with each step.

3. A method according to claim 2 wherein the first process definition comprises common elements reflecting steps in a determined order.

4. A method according to claim 2 wherein the first process definition comprises a common elements reflecting steps within a flow diagram, the steps presented within the flow diagram with alternative and repeating order.

5. A method according to claim 2 wherein the first process definition comprises potential elements that are common to a plurality of instances but other than common to all instances, the potential elements within the determined order.

6. A method according to claim 5 wherein the potential elements are within the first process definition as potential elements different from other than potential elements.

7. A method according to claim 2 wherein analysing the data set to determine different instances of a same first process reflected thereby comprises analysing a plurality of datasets.

8. A method according to claim 2 wherein analysing the data set to determine different instances of a same first process reflected thereby comprises analysing a plurality of datasets comprising at least an email dataset and a financial dataset.

9. A method according to claim 5 wherein a first potential element is stored with potential results indicative of one of improved process flow outcome and inferior process flow outcome to the process flow absent the first potential element.

10. A method according to claim 1 comprising determining a first process instance flow in process and other than complete and displaying a portion of the first process instance flow showing at least a portion of the process flow and the first process instance flow thereon.

11. A method comprising:
analysing a data set to determine first processes reflected thereby;
determining common elements within the first processes;
mapping the common elements within the first processes to provide an estimated process flow;
evaluating an identified process flow to determine a location of the identified process flow within one or more process flows; and
providing a reminder indication relating to at least one of an overdue common element and an upcoming common element within the one or more process flows.

12. A method according to claim 11 wherein common elements include potential common elements and wherein the reminder indication includes an indication when a common element is a potential common element.

13. A method according to claim 11 wherein common elements include potential common elements and wherein the reminder indication includes an indication when a common element is a potential common element and a relative value related to expected changes in outcome when the potential common element occurs.

14. A method comprising:
analysing a plurality of data sets to determine, from a number of process instances, common elements forming part of a first process definition relating to at least a first process flow for a first process;
mapping the common elements within the number of process instances to provide the first process flow for the first process;
evaluating data to extract an unidentified process;
mapping the unidentified process against the first process flow and when the unidentified process is a potential match against a first portion of the first process flow, determining an absence of one or more common elements common to the first process flow; and
providing a map of the first process flow indicating events and documents forming part of the unidentified process within the first process flow.

15. A method according to claim 14 wherein the map includes a mapping of an unidentified process onto the first process flow highlighting at least one of missing common elements and upcoming common elements within he first process flow.

16. A method according to claim 15 wherein the mapping includes an indication of deficiencies within the process flow.

17. A method according to claim 16 wherein the mapping includes an indication of where within the estimated process flow, the indicated process is currently.

18. A method according to claim 14 comprising:
analysing a plurality of data sets to determine, from a number of process instances, second common elements forming part of a second process definition relating to at least a second process flow for a second process;
mapping the second common elements within the number of process instances to provide the second process flow for the second process;
evaluating data to extract a second unidentified process;
mapping the second unidentified process against the second process flow and when the second unidentified process is a potential match against a first portion of the second process flow, determining an absence of one or more common elements common to the second process flow; and
providing a map of the second process flow indicating events and documents forming part of the second unidentified process within the second process flow.

19. A method according to claim 14 wherein common elements include at least some of steps, documents, document classes, fields, fields within documents, and documents including a plurality of known fields.

20. A method according to claim 14 wherein common elements includes each of steps, fields within documents, and documents each including a plurality of known fields.

21. A method according to claim 20 comprising: linking the document fields to a primary source of truth.

22. A method according to claim 20 comprising: linking the steps and document fields to an anchor value.

23. A method according to claim 22 wherein the anchor value is an invoice reference number.
